(19) United States
(12) Patent Application Publication
(10) Pub. No.: US 2015/0198984 A1
(43) Pub. Date: Jul. 16, 2015

(54) Folio for Electronic Device

(71) Applicant: Uncommon LLC, Chicago, IL (US)

(72) Inventors: John Hong, Chicago, IL (US); William Welch, Los Altos, CA (US)

(73) Assignee: Uncommon LLC, Chicago, IL (US)

(21) Appl. No.: 14/042,845

(22) Filed: Oct. 1, 2013

Related U.S. Application Data
(60) Provisional application No. 61/708,228, filed on Oct. 1, 2012.

(51) Int. Cl. G06F 1/18; A45C 11/00; A45C 13/00

(52) U.S. Cl. CPC G06F 1/181; G06F 1/189; A45C 13/002; A45C 13/005; A45C 11/00; A45C 2011/003

(57) ABSTRACT

A folio for an electronic device, the folio having an outer housing, an inner housing within the outer housing and including electronics, and a hinged cover attached to one of either the inner or outer housing. The cover may attach along any of four sides of one of the housings. Further, the electronics of the inner housing are divided into a plurality of components. The sensor circuit board assembly, the main electronics circuit board assembly and the dock connector are separate components. The cover attaches to the inner housing on either or both sides of the sensor assembly and the dock connector is positioned at the opposite end of the inner housing. Preferably, the three separate components are connected by ribbon wire or the like.

### RELATED APPLICATION

The present application claims the filing priority of U.S. Provisional Application Ser. No. 61/708,228, titled “FOLIO FOR ELECTRONIC DEVICE” and filed on Oct. 1, 2012. The '228 application is hereby incorporated by reference.

### TECHNICAL FIELD OF THE INVENTION

The present device relates to folios for electronic devices such as, for example, an Apple iPad.

### BACKGROUND OF THE INVENTION

The portability of electronic devices has led to a need for protecting such devices during transport. Whether it is being carried in a pocket, a purse, a backpack, or even a specially designed carrying case, the monetary investment of an electronic device almost certainly justifies the use of a protective case. However, once put to use, the need for protecting the electronic device is greatly diminished. This is particularly true for tablet-type electronic devices, such as the Apple iPad, which are occasionally used in seated settings and can be placed on a table or similar surface. In some cases, the tablet is more useful in a vertical (or slightly reclined) position. This upright position allows the tablet to have better viewability, but a separate stand is often needed to retain the tablet in such a position.

Further, as these electronic devices are replacing traditional writing tablets, the use of a traditional folio to hold paper, pen, business cards and the like is becoming obsolete as well. Instead, folios are now designed to hold electronic tablet-type device and accessories. However, these new folios have typically required extending the dimensions of the device a considerable distance to allow access to charging ports, switches, buttons and the like. In known folios, all of the electronic components are on a single printed circuit board assembly (PCBA), including the dock connector, which is used to charge and/or sync the electronic device.

This single PCBA configuration is convenient from an engineering perspective, but creates at least two distinct problems. First, a single PCBA is considerably larger than it should be, requiring extension of the dimensions of a folio. Second, the placement of the PCBA in the folio forces the user to use the electronic device upside down.

While there are a limited number of prior art devices which provide combined protection and functionality, such devices are more complicated and/or more bulky than the present device. A protective cover which minimizes extending the electronic device has significant advantages over the prior art.

Until the invention of the present application, these and other problems in the prior art went either unnoticed or unsolved by those skilled in the art. The present invention provides a protective cover, which shields the electronic device from impacts and other destructive occurrences, and allows for quick and simple integration with an electronic device without sacrificing portability features, design, style or affordability.

### SUMMARY OF THE INVENTION

There is disclosed herein an improved electronic device folio which avoids the disadvantages of prior devices while affording additional structural and operating advantages.

Generally speaking, the disclosed folio for an electronic device comprises an outer housing, an inner housing within the outer housing and including electronics, and a hinged cover attached to one of either the inner or outer housing. The cover may attach along any of four sides of one of the housings. Further, the electronics of the inner housing are divided into a plurality of components. Preferably, the sensor circuit board assembly, the main electronics circuit board assembly and the dock connector are separate components.

In a specific embodiment, the cover attaches to the inner housing on either or both sides of the sensor assembly and the dock connector is positioned at the opposite end of the inner housing. Preferably, the electronics are comprised in three separate components connected by ribbon wire or the like.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a schematic illustration of the electronics of an embodiment of a folio in accordance with the present disclosure;

FIG. 2 is a side view of an embodiment of a folio showing the placement of the electronics of FIG. 1;

FIG. 3 is a side view of an embodiment of a folio having a cover connected at the top;

FIG. 4 is top view of an embodiment of a cover; and

FIG. 5 shows two views indicating placement of folio electronics.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

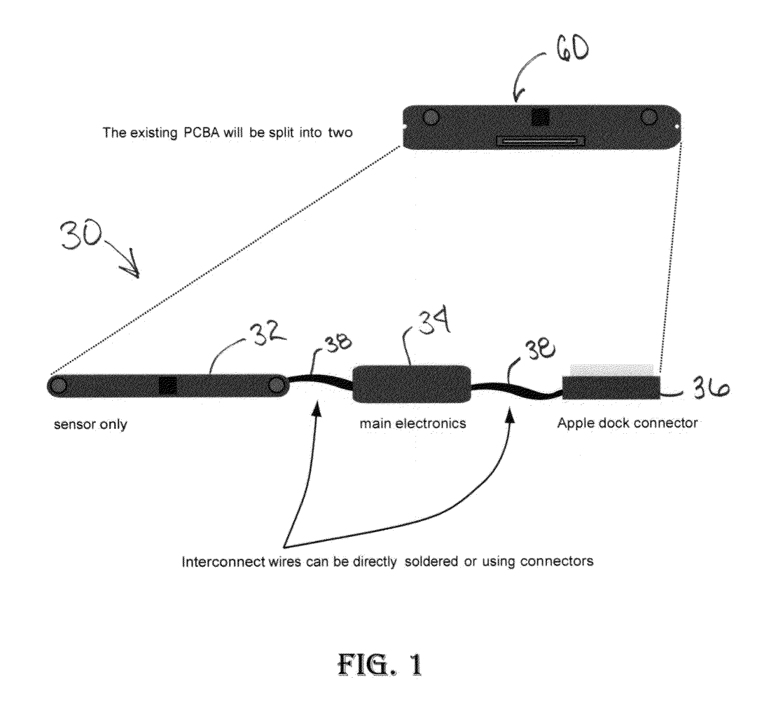

Referring to FIGS. 1-5, there is illustrated an embodiment of an electronic device folio, generally designated by the numeral 10. The particular illustrated folio 10 is for an Apple iPad. In fact, while all the embodiments illustrated are directed to an iPad, it should be understood that the principles of the invention can be more broadly applied to most tablet-type electronic devices, as well as other types of electronic devices such as cell phones, notebook computers and the like, as long as there is a need for a protective cover and a folio type carrying case.

As can be seen in the several figures, the folio 10 is comprised of a base 12 having an outer housing 14, an inner housing 16 positioned within the outer housing 14 and having electronics 18, and a hinged cover 20. The cover 20 may be permanently fixed to the base or it may be detachable in certain embodiments.

The folio 10 allows an electronic device 50 to be connected within the inner housing 16 to the electronics 18 and minimizes the extended area of the folio 10. The minimized extension is a key feature of the present folio.

With respect to FIG. 1, a prior art circuit board assembly 60 is shown at the top of the figure and below that is an embodiment of a preferred three-component PCBA 30 of the present invention. The present PCBA 30 is divided into three components to allow a more compact folio 10. To accomplish this, the existing electronic design is split into two different PCBAs. The sensor PCBA 32 will contain only the bare minimum components possible, and the remaining components will be moved to the main PCBA 34, with the a dock connector 36 getting moved to a cable end instead of being mounted to either PCBA.

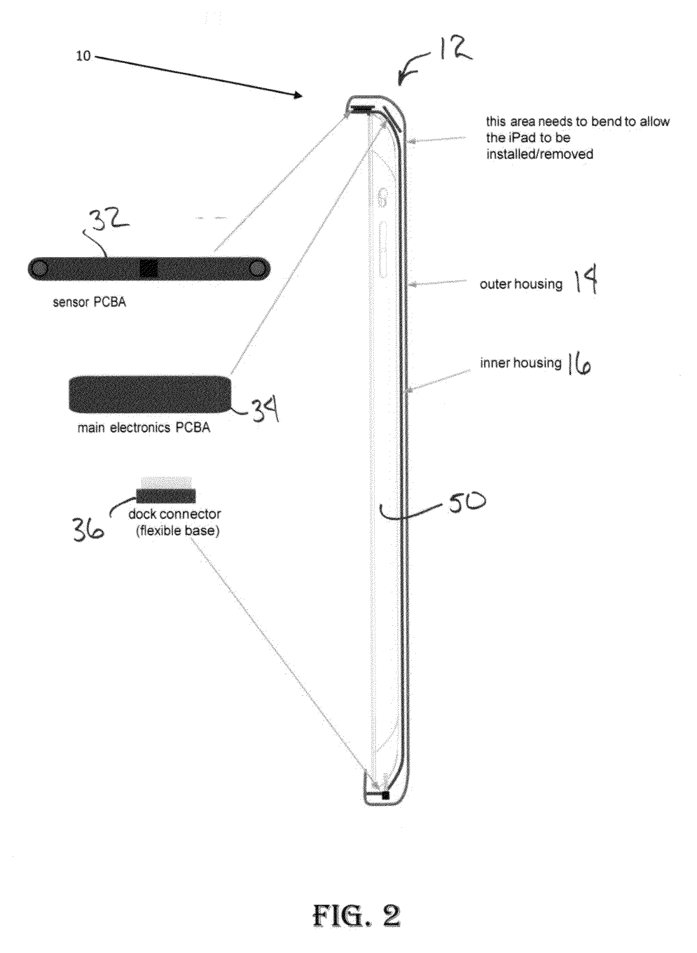

The sensor PCBA 32, main PCBA 34, and the docking connector 36 are all connected together by electronic wiring 38 and connectors. The three-component PCBA 30 is then placed within the outer housing 14 as part of the inner housing 16, as shown in FIG. 2. As shown, the dock connector 36 is positioned at one end of the folio 10 (i.e., the end corresponding to the base/bottom edge of the iPad) with the sensor PCBA 32 and main PCBA 34 positioned at the opposite end.

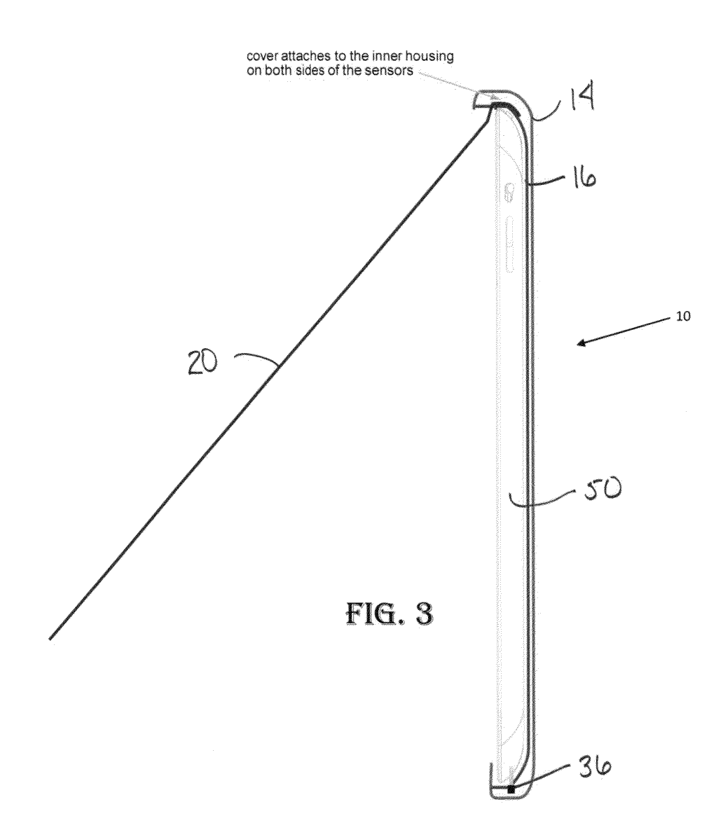

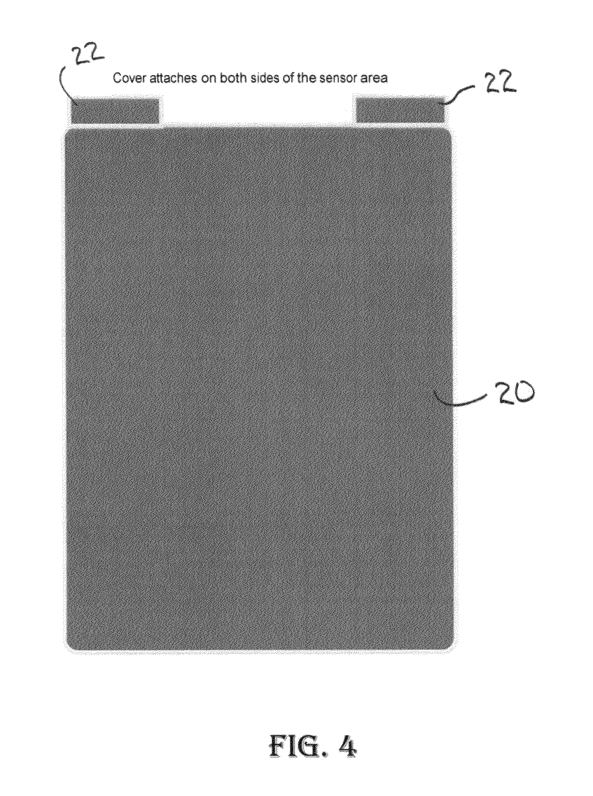

FIG. 3 illustrates the preferred connection of the cover 20 at the inner housing 16 of the folio 10. Flanges 22 of the cover 20, shown best in FIG. 4, attach on both sides of the sensor PCBA 32. Of course, the folio 10 may have a book configuration where the cover 20 closes from the left side rather than the top of the folio 10. Such a configuration is also possible with the present invention, though it is not shown.

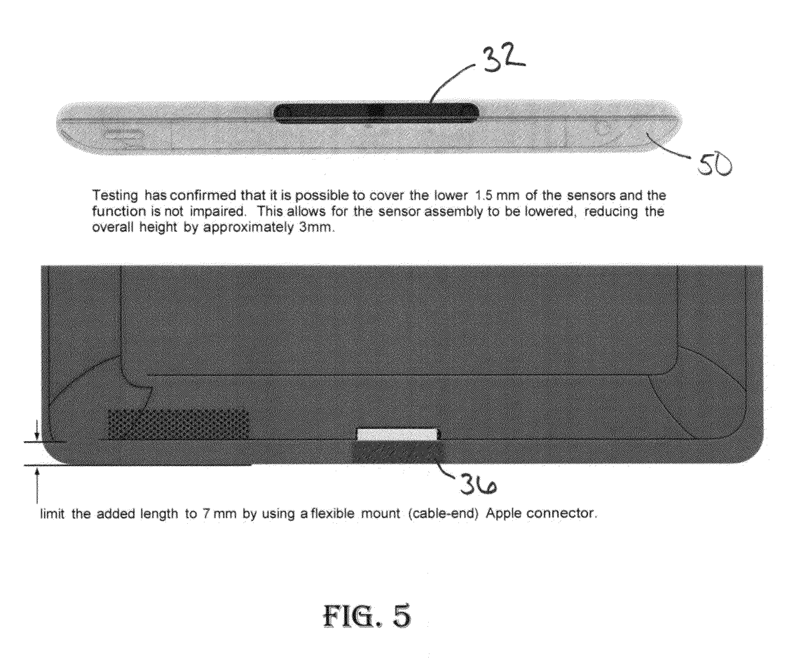

With respect to FIG. 5, the top image shows the position of the sensor PCBA 32 at the top edge of the folio 10 relative to the top (screen face) surface of the electronic device. The PCBA 30 extends a mere (approx.) three millimeters (3 mm) above the surface. Positioning the sensor PCBA 32 at the top edge provides greatly improved user experience as well. Testing this configuration has confirmed that covering the lower 1.5 mm (approx.) of the sensors does not impair function.

The lower image of FIG. 5 illustrates the position of the separate docking connector 36. As noted in the figure, a standard flexible mount (cable end) connector limits the added length to about seven millimeters (7 mm). Even with other connectors, the added length beyond the periphery of the area in which the electronic device is seated can be kept at less than about ten millimeters (10 mm). From a manufacturing standpoint, the independent connector 36 allows the same PCBA to be used on multiple products. The connector 36 may also include an adapter, such as one for charging a phone.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A folio for an electronic device, the folio comprising:
a protective outer housing;
an inner housing positioned within the outer housing and including electronics, wherein the electronics comprise:
a sensor PCBA;
a main electronics PCBA; and
a docking connector; and
a cover attached to one of either the outer housing or the inner housing.

2. The folio of claim 1, wherein the cover is attached to a top edge of the folio.

3. The folio of claim 1, wherein the cover is attached to a side edge of the folio.

4. The folio of claim 1, wherein the docking connector and the sensor PCBA are positioned proximate opposite sides of the inner housing.

5. The folio of claim 1, wherein the inner housing defines an area for seating an electronic device and the electronics extend minimally beyond a periphery of the area for seating the electronic device.

6. The folio of claim 5, wherein the electronics extend less than seven millimeters beyond the periphery of the area for seating the electronic device.

7. The folio of claim 5, wherein the electronics extend less than ten millimeter beyond the periphery of the area for seating the electronic device.

8. The folio of claim 1, wherein the sensor PCBA and the docking connector are connected to the main electronics PCBA via ribbon wire.

9. The folio of claim 1, wherein the docking connector and the main electronics PCBA are positioned within the inner housing at opposing ends.

10. The folio of claim 9, wherein the sensor PCBA is positioned proximate the main electronics PCBA.

11. The folio of claim 1, wherein the cover comprises flanges for attaching to one of either the inner housing and outer housing on both sides of the sensor PCBA.

12. A printed circuit board assembly for an electronic folio having a protective outer housing and an inner housing within the outer housing for securing an electronic device therein, the circuit board assembly comprising:
a sensory assembly configured to attach to an end of the inner housing of the folio;
a main electronics assembly configured to attach to the inner housing of the folio;
a docking connector configured to couple with a port on the electronic device and attach to the inner housing of the folio at an end opposite from the sensory assembly; and
connecting wire connecting the sensory assembly and the docking connector to the main electronics assembly.
